(19) United States
(12) Patent Application Publication
(10) Pub. No.: US 2024/0364568 A1
(43) Pub. Date: Oct. 31, 2024

(54) AUTO-DETECTION OF A PHYSICAL LAYER PROTOCOL DATA UNIT (PPDU) FORMAT FOR NEXT GENERATION WIRELESS NETWORKS

(71) Applicant: NEWRACOM, Inc., Irvine, CA (US)

(72) Inventors: Heejung YU, Daejeon (KR); Joonsoo LEE, Seoul (KR); Si-Chan NOH, Seoul (KR)

(73) Assignee: NEWRACOM, Inc., Irvine, CA (US)

(21) Appl. No.: 18/648,091

(22) Filed: Apr. 26, 2024

Related U.S. Application Data
(60) Provisional application No. 63/499,051, filed on Apr. 28, 2023.

(51) Int. Cl. H04L 27/26; H04W 84/12

(52) U.S. Cl. CPC H04L 27/2603; H04L 27/2613; H04W 84/12

(57) ABSTRACT

Disclosed herein is a method performed by a wireless device operating in a wireless network to transmit a physical layer protocol data unit (PPDU) having a PPDU format that can be auto-detected. The method includes generating a PPDU that includes a legacy signal field, a repeated legacy signal field, a non-legacy signal field, and a repeated non-legacy signal field and wirelessly transmitting the PPDU, wherein non-legacy wireless devices are able to determine that the PPDU has a particular non-legacy PPDU format based on detecting repetitions of the legacy signal field and the non-legacy signal field in the PPDU.

### CROSS-REFERENCE TO RELATED APPLICATION

This application claims the benefit of U.S. Provisional Application No. 63/499,051, filed Apr. 28, 2023, titled, “New frame format auto-detection and range extension method for next generation wireless LANs,” which is hereby incorporated by reference.

### TECHNICAL FIELD

The present disclosure generally relates to wireless communications, and more specifically, relates to auto-detecting a physical layer protocol data unit (PPDU) format in a wireless network.

### BACKGROUND

Institute of Electrical and Electronics Engineers (IEEE) 802.11 is a set of physical and Media Access Control (MAC) specifications for implementing Wireless Local Area Network (WLAN) communications. These specifications provide the basis for wireless network products using the Wi-Fi brand managed and defined by the Wi-Fi Alliance. The specifications define the use of the 2.400-2.500 Gigahertz (GHz) as well as the 4.915-5.825 GHz bands. These spectrum bands are commonly referred to as the 2.4 GHz and 5 GHz bands. Each spectrum is subdivided into channels with a center frequency and bandwidth. The 2.4 GHz band is divided into 14 channels spaced 5 Megahertz (MHz) apart, though some countries regulate the availability of these channels. The 5 GHz band is more heavily regulated than the 2.4 GHz band and the spacing of channels varies across the spectrum with a minimum of a 5 MHz spacing dependent on the regulations of the respective country or territory.

WLAN devices are currently being deployed in diverse environments. These environments are characterized by the existence of many access points (APs) and non-AP stations (STAs) in geographically limited areas. Increased interference from neighboring devices gives rise to performance degradation. Additionally, WLAN devices are increasingly required to support a variety of applications such as video, cloud access, and offloading. Video traffic, in particular, is expected to be the dominant type of traffic in WLAN deployments. With the real-time requirements of some of these applications, WLAN users demand improved performance.

New generations of WLANs have been developed while maintaining an inefficient physical layer protocol data unit (PPDU) format to support backwards compatibility with previous generations of WLANs. WLAN devices operating in the 6 GHz band may use an efficient PPDU format dedicated to the 6 GHz band because the 6 GHz band is a newly adopted frequency. However, some existing WLAN devices (e.g., IEEE 802.11ax and IEEE 802.11be wireless devices) are being used in the 6 GHz band so coexistence and auto-detection of PPDU formats are still needed. Also, transmission power is lower in the 6 GHz band compared to other frequency bands (e.g., 2.4 GHz and 5 GHz bands) due to radio wave regulation in the 6 GHz band, which limits communication range.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example wireless local area network (WLAN) with a basic service set (BSS) that includes a plurality of wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates Inter-Frame Space (IFS) relationships, in accordance with some embodiments of the present disclosure.

FIG. 5 illustrates a Carrier Sense Multiple Access/Collision Avoidance (CSMA/CA) based frame transmission procedure, in accordance with some embodiments of the present disclosure.

FIG. 6 shows a table comparing various iterations of Institute of Electrical and Electronics Engineers (IEEE) 802.11 standard, in accordance with some embodiments of the present disclosure.

FIG. 7 shows a table, which describes fields of an Extreme High Throughput (EHT) frame format, in accordance with some embodiments of the present disclosure.

FIG. 8 is a diagram showing physical layer protocol data unit (PPDU) formats provided by existing wireless networking standards, according to some embodiments.

FIG. 9 is a diagram showing a new PPDU format that uses disregard bits of a universal signal (U-SIG) field to indicate that a PPDU has the new PPDU format, according to some embodiments.

FIG. 10 is a diagram showing a new PPDU format that uses repeated legacy signal (RL-SIG) field repetition to indicate that a PPDU has the new PPDU format, according to some embodiments.

FIG. 11 is a diagram showing a new PPDU format that uses new signal (New-SIG) field repetition to indicate that a PPDU has the new PPDU format, according to some embodiments.

FIG. 12 is a diagram showing a new PPDU format that uses legacy short training field (L-STF) field repetition, legacy long training field (L-LTF) field repetition, and New-SIG field repetition to extend effective communication range, according to some embodiments.

FIG. 13 is a flow diagram showing a method for transmitting a PPDU that has a PPDU format that can be auto-detected, according to some embodiments.

FIG. 14 is a flow diagram showing a method for auto-detecting a PPDU format of a PPDU, according to some embodiments.

### DETAILED DESCRIPTION

One aspect of the present disclosure generally relates to wireless communications, and more specifically, relates to auto-detecting a physical layer protocol data unit (PPDU) format in a wireless network.

As mentioned above, some legacy WLAN devices are being used in the 6 Gigahertz (GHz) band so coexistence and auto-detection of PPDU formats are still needed. Also, transmission power is lower in the 6 GHz band compared to other frequency bands (e.g., 2.4 GHz and 5 GHz bands) due to radio wave regulation in the 6 GHz band, which limits communication range.

Thus, a technology is needed to auto-detect new PPDU formats and to extend the communication range of WLAN devices operating in the 6 GHz band.

The present disclosure introduces new PPDU formats and mechanisms to auto-detect such PPDU formats. The new PPDU formats may be backwards compatible with previous/legacy versions of wireless networking standards. The PPDU formats may be suitable for use in future generations of wireless local area networks (WLANs) that operate in the 6 GHZ band (or other frequency band that becomes available for use), where legacy wireless devices (e.g., wireless devices that use/understand a legacy PPDU format) and non-legacy wireless devices (e.g., wireless devices that use/understand the non-legacy PPDU format) may coexist. In an embodiment, non-legacy wireless devices implement a particular version of the IEEE 802.11 wireless networking standard (e.g., a IEEE 802.11 wireless networking standard that comes after IEEE 802.11bc), while legacy wireless devices implement a previous version of the Institute of Electrical and Electronics Engineers (IEEE) 802.11 wireless networking standard (e.g., IEEE 802.11a/g, IEEE 802.11n, IEEE 802.11ac, IEEE 802.11ax, and/or 802.11bc).

According to some embodiments, a wireless device generates and transmits a PPDU that includes a legacy signal (L-SIG) field, a repeated legacy signal (RL-SIG) field, a non-legacy/new signal (New-SIG) field, and a repeated non-legacy/new (RN-SIG) signal field. Non-legacy wireless devices that receive the PPDU may be able to determine that the PPDU has a particular non-legacy PPDU format (e.g., a PPDU format provided by a new IEEE 802.11 wireless networking standard) based on detecting the repetition of the legacy signal field and the repetition of the non-legacy signal field in the PPDU. Repeating the legacy signal field and the non-legacy/new signal field may provide the effect of extending the communication range of the PPDU. According to some embodiments, the PPDU may be generated to further include a legacy short training field (L-STF), a repeated legacy short training field, a legacy long training field (L-LTF), and a repeated legacy long training field. The repetition of the legacy short training field and the repetition of the legacy long training field may provide the effect of extending the communication range of the PPDU (as much as the legacy signal field repetition and non-legacy signal field repetition provided).

For purposes of illustration, various embodiments are described herein in the context of wireless networks that are based on IEEE 802.11 wireless networking standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

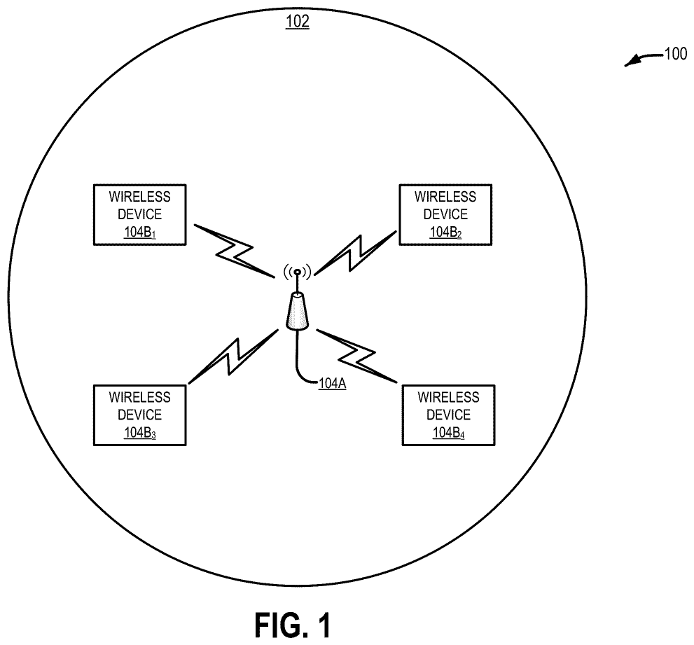

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs. Although shown with four non-AP STAs (e.g., the wireless devices 104B₁-104B₄), the WLAN 100 may include any number of non-AP STAs (e.g., one or more wireless devices 104B).

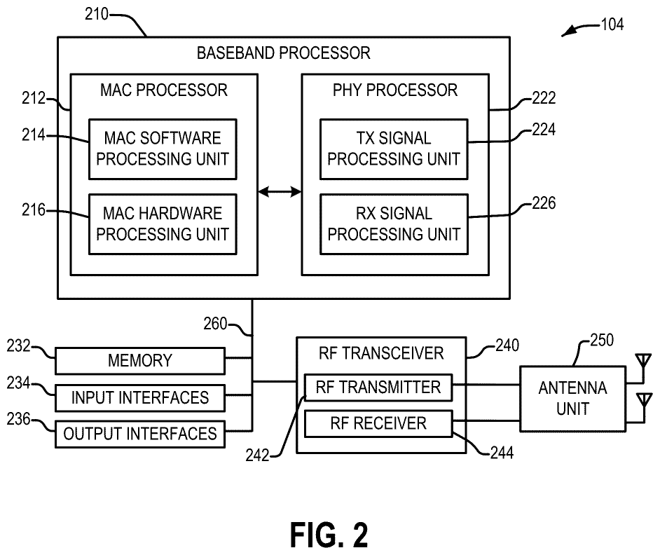

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in cither hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

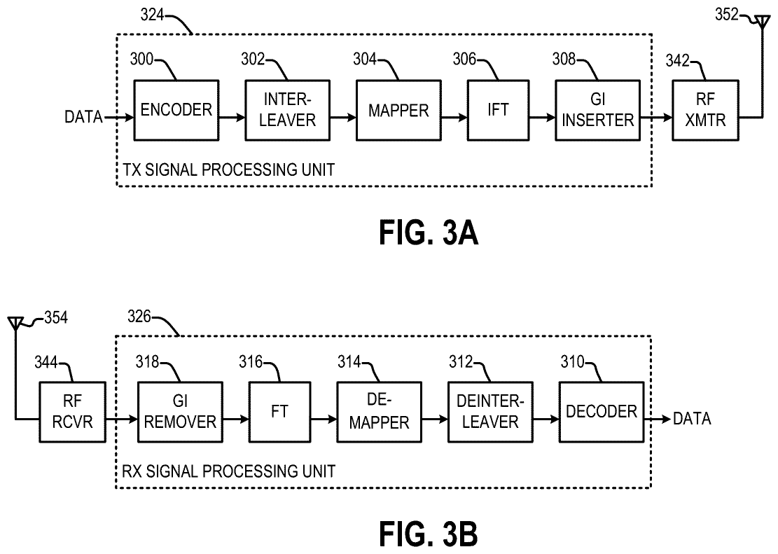

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of Os or Is. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In cither OFDM or OFDMA Physical (PHY) layers, a STA (e.g., a wireless device 104) is capable of transmitting and receiving Physical Layer (PHY) Protocol Data Units (PPDUs) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

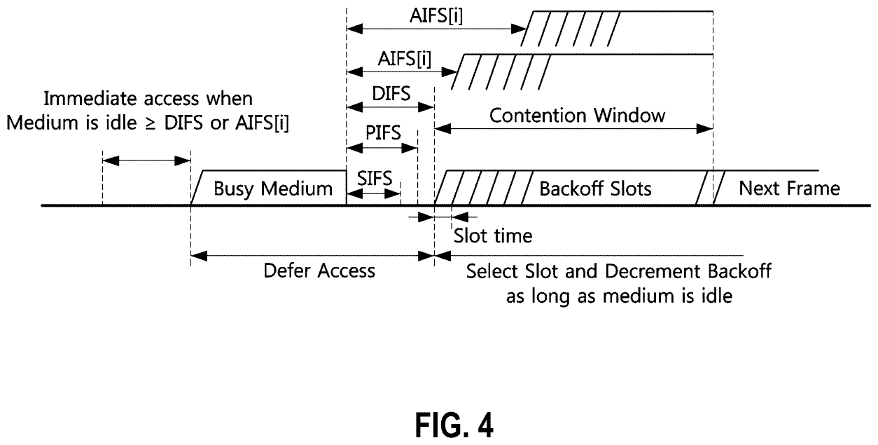

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS [i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS [AC]) has elapsed. When transmitted by the QoS STA, any of the data frame, the management frame, and the control frame, which is not the response frame, may usc the AIFS [AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

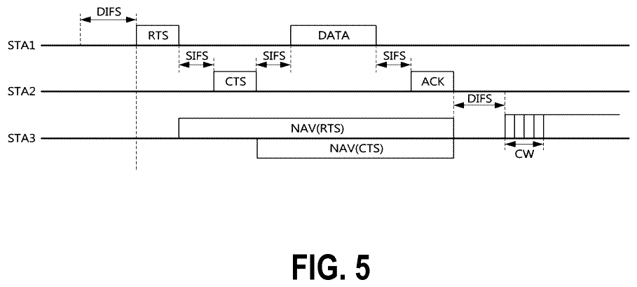

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period clapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

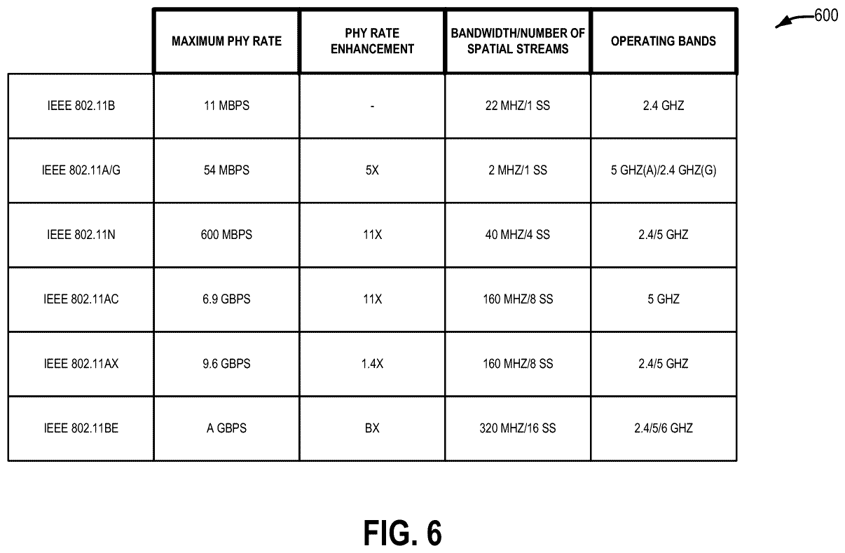

With clear demand for higher peak throughput/capacity in a WLAN, a new working group has been assembled to generate an amendment to IEEE 802.11. This amendment is called IEEE 802.11bc (i.e., Extreme High Throughput (EHT)) and was created to support an increase to the peak PHY rate of a corresponding WLAN. Considering IEEE 802.11b through 802.11ac, the peak PHY rate has been increased by 5× to 11× as shown in FIG. 6, which presents a table 600 comparing various iterations of IEEE 802.11. In case of IEEE 802.11ax, the 802.11ax working group focused on improving efficiency, not peak PHY rate in dense environments. The maximum PHY rate (A Gbps) and PHY rate enhancement (Bx) for IEEE 802.11be could rely on the highest MCS (e.g., 4,096 QAM and its code rate).

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHZ) is being considered for unlicensed use. This would allow APs and STAs to become tri-band devices. Larger than 160 MHz data transmissions (e.g., 320 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

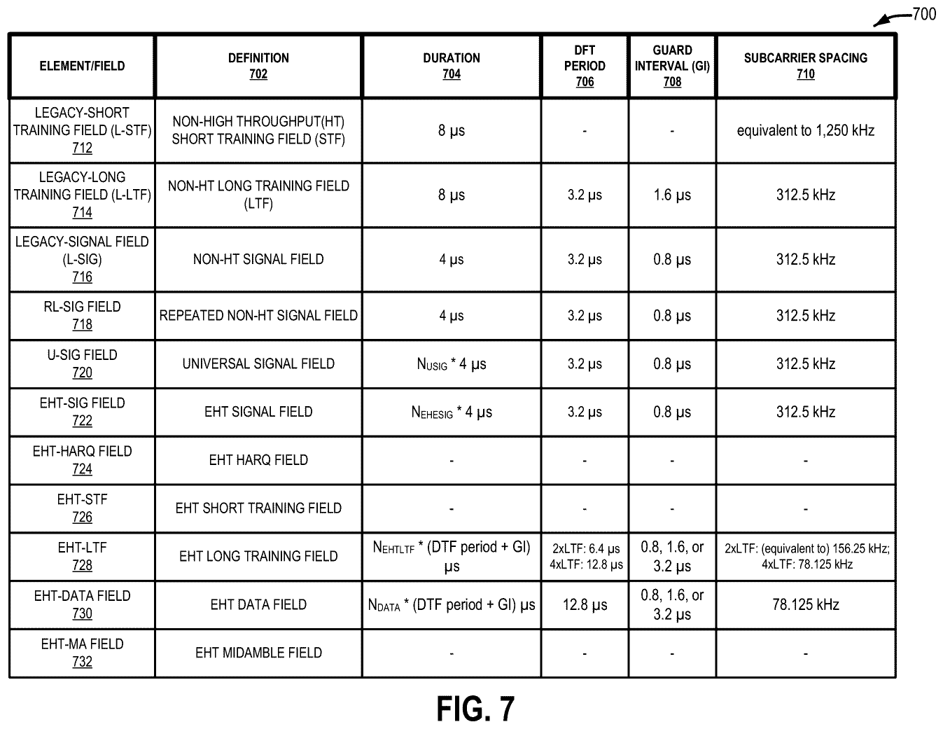

In some embodiments, a transmitting STA generates a PPDU frame and transmits it to a receiving STA. The receiving STA receives, detects, and processes the PPDU. The PPDU can be an EHT PPDU that includes a legacy part (e.g., a legacy short training field (L-STF), a legacy long training field (L-LTF), and a legacy signal (L-SIG) field), an EHT signal A field (EHT-SIG-A), an EHT signal B field (EHT-SIG-B), an EHT hybrid automatic repeat request field (EHT-HARQ), an EHT short training field (EHT-STF), an EHT long training field (EHT-LTF), and an EHT-DATA field. FIG. 7 includes a table 700, which describes fields of an EHT frame format. In particular, table 700 describes various fields that may be within the PHY preamble, data field, and midamble of an EHT frame format. For example, table 700 includes definitions 702, durations 704, Discrete Fourier transform (DFTs) periods 706, guard intervals (GIs) 708, and subcarrier spacings 710 for one or more of a legacy short training field (L-STF) 712, legacy long training field (L-LTF) 714, legacy signal field (L-SIG) 716, repeated L-SIG (RL-SIG) 718, universal signal field (U-SIG) 720, EHT signal field (EHT-SIG) 722, EHT hybrid automatic repeat request field (EHT-HARQ) 724, EHT short training field (EHT-STF) 726, EHT long training field (EHT-LTF) 728, EHT data field 730, and EHT midamble field (EHT-MA) 732.

The distributed nature of a channel access network, such as in IEEE 802.11 wireless networks, makes carrier sensing mechanisms important for collision free operation. The physical carrier sensing mechanism of one STA is responsible for detecting the transmissions of other STAs. However, it may be impossible to detect every single case in some circumstances. For example, one STA which may be a long distance away from another STA may see the medium as idle and begin transmitting a frame while the other STA is also transmitting. To overcome this hidden node, a network allocation vector (NAV) may be used. However, as wireless networks evolve to include simultaneous transmission/reception to/from multiple users within a single basic service set (BSS), such as uplink (UL)/downlink (DL) multi-user (MU) transmissions in a cascading manner, a mechanism may be needed to allow for such a situation. As used herein, a multi-user (MU) transmission refers to cases that multiple frames are transmitted to or from multiple STAs simultaneously using different resources. Examples of different resources are different frequency resources in OFDMA transmissions and different spatial streams in MU-MIMO transmissions. Therefore, DL-OFDMA, DL-MU-MIMO, UL-OFDMA, and UL-MU-MIMO are examples of MU transmissions.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

To improve WLAN systems, AP cooperation has been discussed as a possible technology to be adopted in IEEE 802.11be, where there is high level classification depending on various AP cooperation schemes. For example, there is a first type of cooperation scheme in which data for a user is sent from a single AP (sometimes referred to as “coordinated”) and there is a second type of cooperation scheme in which data for a user is sent from multiple APs (sometimes referred to as “joint”).

For the coordinated scheme, multiple APs are 1) transmitting on the same frequency resource based on coordination and forming spatial nulls to allow for simultaneous transmission from multiple APs or 2) transmitting on orthogonal frequency resources by coordinating and splitting the spectrum to use the spectrum more efficiently. For the joint scheme, multiple APs are transmitting jointly to a given user.

When a new wireless networking standard (e.g., IEEE 802.11 wireless networking standard) is introduced, it may provide a new PPDU format and a mechanism to automatically detect when a PPDU has the new PPDU format. The new PPDU format may be designed to be backwards compatible with previous/legacy versions of the wireless networking standard. For example, the IEEE 802.11n wireless networking standard (also referred to as high throughput (HT)) provides a HT PPDU format in which quadrature binary phase-shift keying (Q-BPSK) modulation (which can be distinguished from binary phase-shift keying (BPSK) modulation used in earlier wireless networking standards (e.g., IEEE 802.11a/g)) is applied to the HT-SIG1 (high throughput signal 1) field and the rate field in the L-SIG field is set to 6 Megabits per second (Mbps) to help distinguish the HT PPDU format from previous PPDU formats. The IEEE 802.11ac wireless networking standard (also referred to as very high throughput (VHT)) provides a VHT PPDU format in which BPSK modulation is applied to the VHT-SIG-A1 field and Q-BPSK modulation is applied to the VHT-SIG-A2 field to help distinguish the VHT PPDU format from previous PPDU formats. The IEEE 802.11ax wireless networking standard (also referred to as high efficiency (HE)) and the IEEE 802.11be wireless networking standard (also referred to as extremely high throughput (EHT)) provide a HE PPDU format and EHT PPDU format, respectively, that each include a repeated signal (RL-SIG) field that repeats the legacy signal (L-SIG) field to help distinguish the HE/EHT PPDU formats from previous/legacy PPDU formats. Phase modulation is used in the HE PPDU format (IEEE 802.11ax), while the EHT PPDU format (IEEE 802.11bc) includes PHY version information in a signal field (e.g., in a U-SIG field) to make it easier to extend the PPDU format for use in future generations of wireless networks.

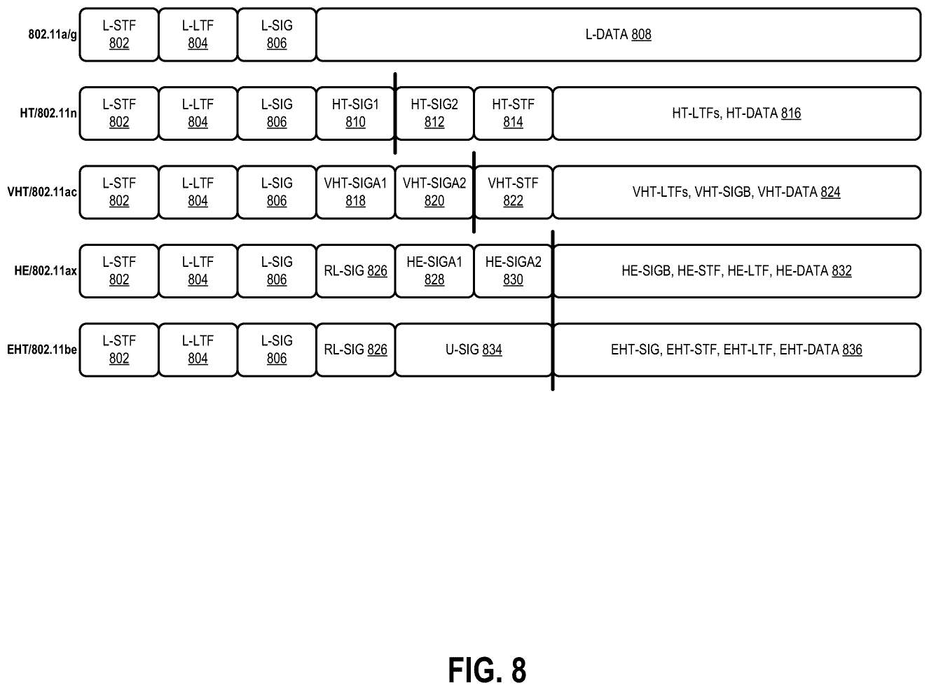

FIG. 8 is a diagram showing PPDU formats provided by existing wireless networking standards, according to some embodiments.

As shown in the diagram, the PPDU format provided by the IEEE 802.11a/g wireless networking standard(s) includes a L-STF field 802, a L-LTF field 804, a L-SIG field 806, and a legacy data (L-DATA) field 808.

The HT PPDU format provided by the IEEE 802.11n wireless networking standard includes a L-STF field 802, a L-LTF field 804, and a L-SIG field 806 for backwards compatibility. The HT PPDU format further includes a HT-SIG1 field 810, a HT-SIG2 field 812, a HT-STF field 814, and additional fields 816 (e.g., which may include HT-LTF field(s) and a HT-DATA field).

The VHT PPDU format provided by the IEEE 802.11ac wireless networking standard includes a L-STF field 802, a L-LTF field 804, and L-SIG field 806 for backwards compatibility. The VHT PPDU format further includes a VHT-SIGA1 field 818, a VHT-SIGA2 field 820, a VHT-STF field 822, and additional fields 824 (e.g., which may include VHT-LTF field(s), VHT-SIGB field, and a VHT-DATA field).

The HE PPDU format provided by the IEEE 802.11ax wireless networking standard includes a L-STF field 802, a L-LTF field 804, and L-SIG field 806 for backwards compatibility. The HE PPDU format further includes a repeated L-SIG (RL-SIG) field 826, a HE-SIGA1 field 828, a HE-SIGA2 field 830, and additional fields 832 (e.g., which may include a HE-SIGB field, a HE-STF field, a HE-LTF field, and HE-DATA field).

The EHT PPDU format provided by the IEEE 802.11be wireless networking standard includes a L-STF field 802, a L-LTF field 804, and L-SIG field 806 for backwards compatibility. The HE PPDU format further includes a RL-SIG field 826, a universal signal (U-SIG) field 834, and additional fields 836 (e.g., which may include a EHT-SIG field, a EHT-STF field, a EHT-LTF field, and EHT-DATA field).

The following rules may be used to detect the various PPDU formats shown in the diagram:
HT: LENGTH % 3==0+SIG1 QBPSK (+SIG2 QBPSK)

As summarized above, a wireless device may determine that a PPDU has a HT PPDU format if the length (indicated in the L-SIG field) modulo 3 is 0 (the length is a multiple of three) and the PPDU includes a SIG1 field (a HT-SIG1 field) (and also a SIG2 field (a HT-SIG2 field)) that is modulated using Q-BPSK modulation.
VHT: LENGTH % 3==0+SIGA1 BPSK+SIGA2 QBPSK

As summarized above, a wireless device may determine that a PPDU has a VHT PPDU format if the length (indicated in the L-SIG field) modulo 3 is 0, the PPDU includes a SIGA1 field (VHT-SIGA1 field) that is modulated using BPSK modulation, and the PPDU further includes a SIGA2 field (VHT-SIGA2 field) that is modulated using Q-BPSK modulation.
HE SU/MU: LENGTH % 3≠0+RLSIG+SIGA1 BPSK+SIGA2 BPSK

As summarized above, a wireless device may determine that a PPDU has a HE SU/MU (single user or multi-user) PPDU format if the length (indicated in the L-SIG field) modulo 3 is not 0 (the length is not a multiple of 3), the PPDU includes a RL-SIG field, and the PPDU further includes a SIGA1 field (a HE-SIGA1 field) and a SIGA2 field (a HE-SIGA2 field) that are modulated using BPSK modulation.
HE ER SU: LENGTH % 3≠0+RLSIG+SIGA1 BPSK+SIGA2 QBPSK

As summarized above, a wireless device may determine that a PPDU has a HE ER (extended range) SU (single user) PPDU format if the length (indicated in the L-SIG field) modulo 3 is not 0 (the length is not a multiple of 3), the PPDU includes a RL-SIG field, and the PPDU further includes a SIGA1 field (a HE-SIGA field) that is modulated using BPSK modulation and a SIGA2 field (a HE-SIGA2 field) that is modulated using Q-BPSK modulation.
EHT: LENGTH % 3==0+RLSIG+U-SIG BPSK->PPDU bits in U-SIG

As summarized above, a wireless device may determine that a PPDU has a EHT PPDU format if the length (indicated in the L-SIG field) modulo 3 is 0, the PPDU includes a RL-SIG field, the PPDU further includes a U-SIG field that is modulated using BPSK modulation, and bits in the U-SIG field (PHY version identifier bits (e.g., bits B0-B2 of the U-SIG-1 field)) indicate that the PPDU has a EHT PPDU format.

However, the PHY version information applied to IEEE 802.11be is used to identify the wireless networking standard version, and there is a limit that it cannot be used to identify other PPDU formats.

New PPDU formats and mechanisms to auto-detect the new PPDU formats are now described with reference to the accompanying figures.

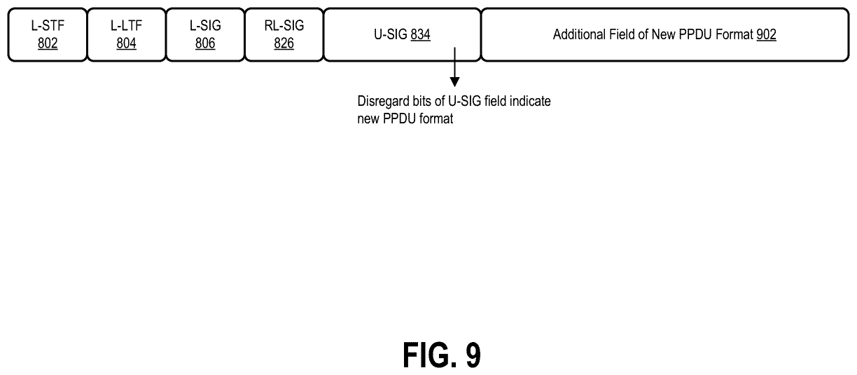

FIG. 9 is a diagram showing a new PPDU format that uses disregard bits of a U-SIG field to indicate that a PPDU has the new PPDU format, according to some embodiments.

As shown in the diagram, the new PPDU format includes a L-STF field 802, a L-LTF field 804, a L-SIG field 806, a RL-SIG field 826, a U-SIG field 834, and additional fields 902. The U-SIG field 834 may include disregard bits (e.g., bits B20-B25 of U-SIG-1 field) that indicate that the PPDU has the new PPDU format.

In an embodiment, the following rule is used to detect that a PPDU has the new PPDU format:
LENGTH % 3==0+RLSIG+U-SIG BPSK->PPDU bits in U-SIG->new frame format indication in disregard bits

As summarized above, a wireless device may determine that a PPDU has the new PPDU format if the length (indicated in the L-SIG field) modulo 3 is 0, the PPDU includes a RL-SIG field, the PPDU further includes a U-SIG field that is modulated using BPSK modulation, and the disregard bits in the U-SIG field indicate that the PPDU has the new PPDU format.

An advantage of the new PPDU format shown in FIG. 9 is that it is simple to implement because it uses the existing disregard bits of the U-SIG field to indicate that the PPDU has the new PPDU format.

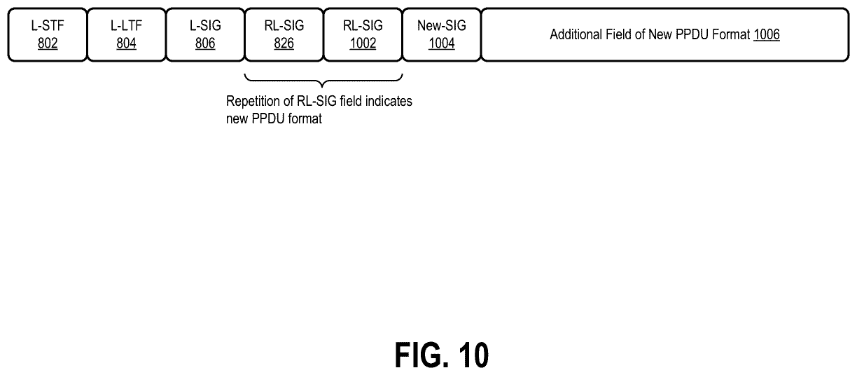

FIG. 10 is a diagram showing a new PPDU format that uses RL-SIG field repetition to indicate that a PPDU has the new PPDU format, according to some embodiments.

As shown in the diagram, the new PPDU format includes a L-STF field 802, a L-LTF field 804, a L-SIG field 806, a RL-SIG field 826, a repeated RL-SIG field 1002, a non-legacy/new signal (New-SIG) field 1004, and additional fields 1006. The repeated RL-SIG field 1002 may be a repetition of the RL-SIG field 826. The new signal field 1004 may be a new field that is added as part of a non-legacy/new version of a wireless networking standard (e.g., to hold information related to new functionality provided by the new version of the wireless networking standard).

In an embodiment, the following rule is used to detect that a PPDU has the new PPDU format:
LENGTH % 3==0+RLSIG+RLSIG+New-SIG

As summarized above, a wireless device may determine that a PPDU has the new PPDU format if the length (indicated in the L-SIG field) modulo 3 is 0 and the PPDU includes a RL-SIG field, a repeated RL-SIG field, and a New-SIG field.

The RL-SIG field may be repeated to distinguish the PPDU format from previous PPDU formats and the new-SIG field 1004 can be used to provide new information that is part of the non-legacy/new version of the wireless networking standard.

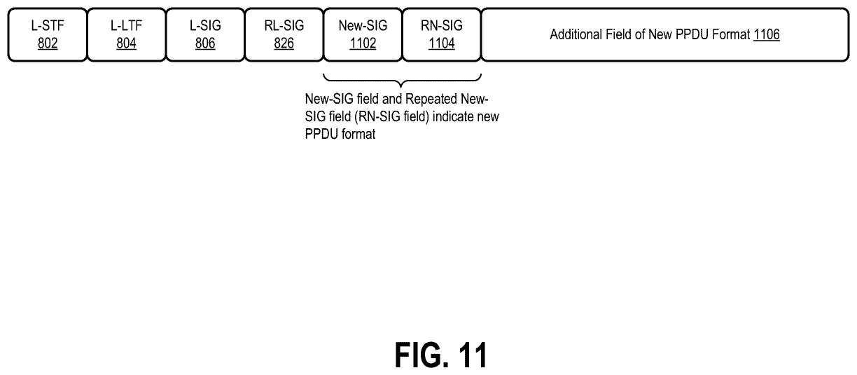

FIG. 11 is a diagram showing a new PPDU format that uses New-SIG field repetition to indicate that a PPDU has the new PPDU format, according to some embodiments.

As shown in the diagram, the new PPDU format includes a L-STF field 802, a L-LTF field 804, a L-SIG field 806, a RL-SIG field 826, a New-SIG field 1102, a repeated New-SIG (RN-SIG) field 1104, and additional fields 1106. The New-SIG field 1102 may be a non-legacy/new field that is added as part of a new version of a wireless networking standard. The RN-SIG field 1104 may be a repetition of the New-SIG field 1102.

In an embodiment, the following rule is used to detect that a PPDU has the new PPDU format:
LENGTH % 3==0+RLSIG+New-SIG+RN-SIG

As summarized above, a wireless device may determine that a PPDU has the new PPDU format if the length (indicated in the L-SIG field) modulo 3 is 0 and the PPDU includes a RL-SIG field, a New-SIG field, and a RN-SIG field.

Similar to how the L-SIG field is repeated, the new-SIG field may also be repeated to distinguish the PPDU format from previous PPDU formats.

More generally, the PPDU format can be identified by the number of RL-SIG repetitions and/or the number of RN-SIG repetitions. Also, different PPDU formats can be used/indicated in different bandwidth units (e.g., different channels or frequency bands) in a wireless network. Thus, auto-detection of the PPDU format is possible in the time and frequency domain. The repetition of fields may improve performance as well (e.g., improve the signal-to-noise ratio (SNR)).

An advantage of the new PPDU format shown in FIG. 11 is that it provides a ˜2× (two times) performance improvement effect (e.g., improve SNR based on averaging repeated symbols) by repeating the New-SIG field 1102 (in addition to repeating the L-SIG field 806). Thus, this new PPDU format shown in FIG. 11 may provide longer effective communication range compared to the new PPDU format shown in FIG. 10. However, auto-detection latency is increased by one symbol.

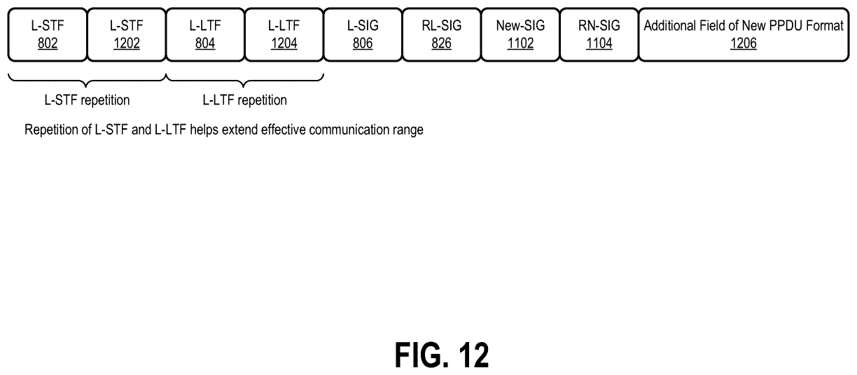

FIG. 12 is a diagram showing a new PPDU format that uses L-STF field repetition, L-LTF field repetition, and New-SIG field repetition to extend effective communication range, according to some embodiments.

Compared to the 2.4 GHz and 5 GHz bands, the path loss in the 6 GHz band is relatively large so the radio propagation distance is shorter. To address this problem, the effective communication range if a PPDU can be extended by repeating transmission of the signal fields (e.g., repeating transmission of the L-SIG field and/or the New-SIG field). By repeating the signal field, a 3 decibel (dB) gain can be obtained from the signal field symbols when compared to legacy wireless networking standards that do not use signal field repetition, but the L-STF field and the L-LTF field remain the same, which limits the effective communication range extension. The L-STF field and L-LTF field are used for performing carrier sensing, timing/frequency offset correction, symbol synchronization, and/or channel estimation. In an embodiment, in addition to repeating the L-SIG field and the new-SIG field, the L-STF field and the L-LTF field are repeated in a PPDU to achieve a communication range extension effect (e.g., as much as the improvement provided by the repetition of the signal field(s)).

For example, as shown in the diagram, the new PPDU format may include a L-STF field 802, a repeated L-STF field 1202, a L-LTF field 804, a repeated L-LTF field 1204, a L-SIG field 806, a RL-SIG field 826, a New-SIG field 1102, a RN-SIG field 1104, and additional fields 1206. The repeated L-STF field 1202 may be a repetition of the L-STF field 802. The repeated L-LTF field 1204 may be a repetition of the L-LTF field 804. The repetition of the L-STF field 802 and the L-LTF field 804 may help with effectively extending the communication range of the PPDU. Such PPDU format may be suitable for use in future wireless networking standards that operate in the 6 GHz band or other band in which path loss is large, transmission power is lower (e.g., due to regulations), and/or communication range is otherwise limited.

New PPDU formats and mechanisms to auto-detect such PPDU formats have been described herein. The new PPDU formats may be used in next generation wireless networks (e.g., that are to operate in 6 GHz band), where backwards compatibility with previous versions/generations of wireless networking standards are desired.

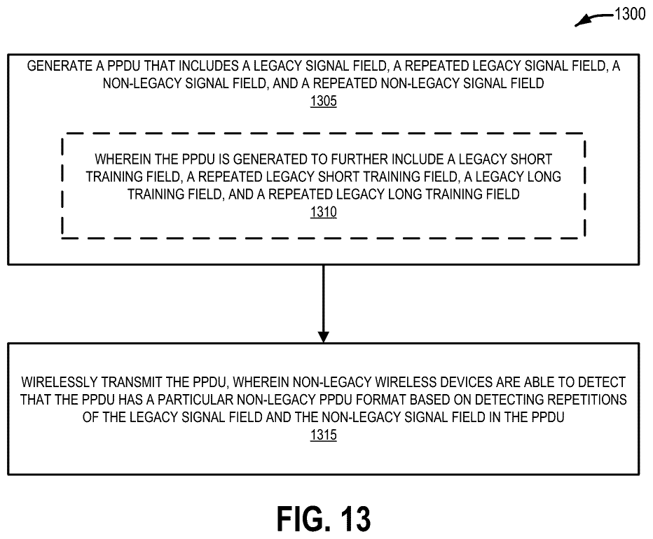

Turning now to FIG. 13, a method 1300 will be described for transmitting a PPDU that has a PPDU format that can be auto-detected, in accordance with an example embodiment. The method 1300 may be performed by one or more devices described herein. For example, the method 1300 may be performed by a wireless device operating in a wireless network (e.g., wireless device 104).

Additionally, although shown in a particular order, in some embodiments the operations of the method 1300 (and the other methods shown in the other figures) may be performed in a different order. For example, although the operations of the method 1300 are shown in a sequential order, some of the operations may be performed in partially or entirely overlapping time periods.

At operation 1305, the wireless device generates a PPDU that includes a legacy signal field (e.g., L-SIG field), a repeated legacy signal field (e.g., RL-SIG field), a non-legacy signal field (e.g., New-SIG field), and a repeated non-legacy signal field (e.g., RN-SIG field). In an embodiment, as shown in block 1310, the PPDU is generated to further include a legacy short training field (e.g., L-STF field), a repeated legacy short training field (e.g., repetition of L-STF field), a legacy long training field (e.g., a L-LTF field), and a repeated long training field (e.g., repetition of L-LTF field) (e.g., to provide a communication range extension effect, as described herein). The aforementioned fields may be included in a preamble of the PPDU.

At operation 1315, the wireless device wirelessly transmits the PPDU, wherein non-legacy wireless devices are able to determine that the PPDU has a particular non-legacy PPDU format based on detecting repetitions of the legacy signal field and the non-legacy signal field in the PPDU. The particular non-legacy PPDU format may be a PPDU format that is provided by a particular version of a wireless networking standard. The non-legacy wireless devices may be wireless devices that implement the particular version of the wireless networking standard. The term “legacy” may refer to version(s) of the wireless networking standard that come before the particular version of the wireless networking standard. In an embodiment, the PPDU is transmitted in a 6 GHz band.

In an embodiment, the legacy signal field indicates a length of the PPDU, wherein the non-legacy wireless devices are able to determine that the PPDU has the particular non-legacy PPDU format further based on the length of the PPDU indicated in the legacy signal field being a multiple of three (the length modulo 3 is zero).

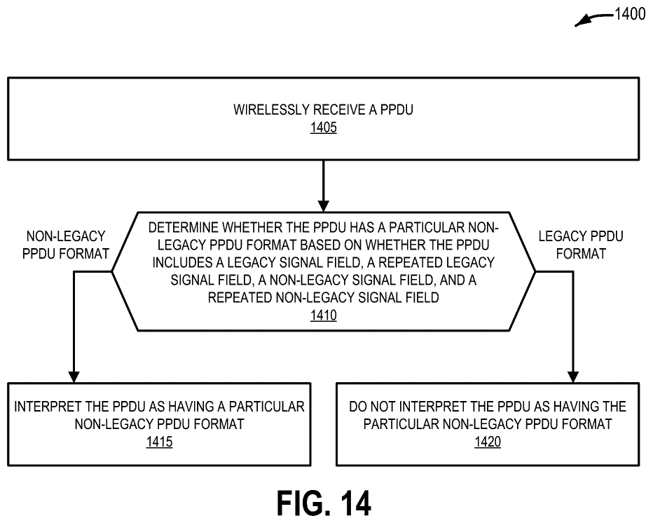

Turning now to FIG. 14, a method 1400 will be described for auto-detecting a PPDU format of a PPDU, in accordance with an example embodiment. The method 1400 may be performed by one or more devices described herein. For example, the method 1400 may be performed by a wireless device operating in a wireless network (e.g., wireless device 104).

At operation 1405, the wireless device wireless receives a PPDU. In an embodiment, the PPDU is received in a 6 GHz band.

At operation 1410, the wireless device determines whether the PPDU has a particular non-legacy PPDU format based on determining whether the PPDU includes a legacy signal field (e.g., L-SIG field), a repeated legacy signal field (e.g., RL-SIG field), a non-legacy signal field (e.g., New-SIG field), and a repeated non-legacy signal field (e.g., RN-SIG field) in the PPDU. The aforementioned fields may be included in a preamble of the PPDU. If the PPDU has the particular non-legacy PPDU format, the flow moves to operation 1415, where the wireless device interprets/processes the PPDU as having the particular non-legacy PPDU format. Otherwise, if the PPDU does not have the particular non-legacy PPDU format (e.g., it has a legacy PPDU format) the flow moves to operation 1420, where the wireless device does not interpret the PPDU as having the particular non-legacy PPDU format.

The particular non-legacy PPDU format may be a PPDU format that is provided by a particular version of a wireless networking standard. The wireless device may be wireless devices that implements the particular version of the wireless networking standard. The term “legacy” may refer to version(s) of the wireless networking standard that come before the particular version of the wireless networking standard.

In an embodiment, the PPDU is determined to have the particular non-legacy PPDU format further based on a determination that a length of the PPDU indicated in the legacy signal field is a multiple of three.

In an embodiment, the PPDU further includes a legacy short training field (e.g., L-STF field), a repeated legacy short training field (e.g., repetition of L-STF field), a legacy long training field (e.g., L-LTF field), and a repeated long training field (e.g., repetition of L-LTF field) that precede the legacy signal field, the repeated legacy signal field, the non-legacy signal field, and the repeated non-legacy signal field (e.g., to provide a communication range extension effect, as described herein). The aforementioned field may be included in a preamble of the PPDU.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a wireless device operating in a wireless network to transmit a physical layer protocol data unit (PPDU) having a PPDU format that can be auto-detected, the method comprising:
generating the PPDU to include a legacy signal field, a repeated legacy signal field, a non-legacy signal field, and a repeated non-legacy signal field; and
wirelessly transmitting the PPDU, wherein non-legacy wireless devices are able to determine that the PPDU has a particular non-legacy PPDU format based on detecting repetitions of the legacy signal field and the non-legacy signal field in the PPDU.

2. The method of claim 1, wherein the PPDU is generated to further include a legacy short training field, a repeated legacy short training field, a legacy long training field, and a repeated long training field.

3. The method of claim 1, wherein the legacy signal field indicates a length of the PPDU, wherein the non-legacy wireless devices are able to determine that the PPDU has the particular non-legacy PPDU format further based on the length of the PPDU indicated in the legacy signal field being a multiple of three.

4. The method of claim 1, wherein the PPDU is transmitted in a 6 Gigahertz (GHz) band.

5. The method of claim 1, wherein the particular non-legacy PPDU format is provided by a particular version of a wireless networking standard.

6. A method performed by a wireless device operating in a wireless network to auto-detect a physical layer protocol data unit (PPDU) format of a PPDU, the method comprising:
wirelessly receiving the PPDU;
determining that the PPDU has a particular non-legacy PPDU format based on detecting a legacy signal field, a repeated legacy signal field, a non-legacy signal field, and a repeated non-legacy signal field in the PPDU; and
interpreting the PPDU as having the particular non-legacy PPDU format in response to determining that the PPDU has the particular non-legacy PPDU format.

7. The method of claim 6, wherein the PPDU further includes a legacy short training field, a repeated legacy short training field, a legacy long training field, and a repeated long training field that precede the legacy signal field, the repeated legacy signal field, the non-legacy signal field, and the repeated non-legacy signal field.

8. The method of claim 6, wherein the PPDU is determined to have the particular non-legacy PPDU format further based on a determination that a length of the PPDU indicated in the legacy signal field is a multiple of three.

9. The method of claim 6, wherein the PPDU is received in a 6 Gigahertz (GHz) band.

10. The method of claim 6, wherein the particular non-legacy PPDU format is provided by a particular version of a wireless networking standard.

11. A wireless device comprising:
a radio frequency transceiver;
a memory device storing a set of instructions; and
a processor coupled to the memory device, wherein the set of instructions when executed by the processor causes the wireless device to:
generate a physical layer protocol data unit (PPDU) that includes a legacy signal field, a repeated legacy signal field, a non-legacy signal field, and a repeated non-legacy signal field and
wirelessly transmit the PPDU via the radio frequency transceiver, wherein non-legacy wireless devices are able to determine that the PPDU has a particular non-legacy PPDU format based on detecting repetitions of the legacy signal field and the non-legacy signal field in the PPDU.

12. The wireless device of claim 11, wherein the PPDU is generated to further include a legacy short training field, a repeated legacy short training field, a legacy long training field, and a repeated long training field.

13. The wireless device of claim 11, wherein the legacy signal field indicates a length of the PPDU, wherein the non-legacy wireless devices are able to determine that the PPDU has the particular non-legacy PPDU format further based on the length of the PPDU indicated in the legacy signal field being a multiple of three.

14. The wireless device of claim 11, wherein the PPDU is transmitted in a 6 Gigahertz (GHz) band.

15. The wireless device of claim 11, wherein the particular non-legacy PPDU format is provided by a particular version of a wireless networking standard.

16. A wireless device comprising:
a radio frequency transceiver;
a memory device storing a set of instructions; and
a processor coupled to the memory device, wherein the set of instructions when executed by the processor causes the wireless device to:
wirelessly receive a physical layer protocol data unit (PPDU),
determining that the PPDU has a particular non-legacy PPDU format based on detecting a legacy signal field, a repeated legacy signal field, a non-legacy signal field, and a repeated non-legacy signal field in the PPDU, and
interpreting the PPDU as having the particular non-legacy PPDU format in response to determining that the PPDU has the particular non-legacy PPDU format.

17. The wireless device of claim 16, wherein the PPDU further includes a legacy short training field, a repeated legacy short training field, a legacy long training field, and a repeated long training field that precede the legacy signal field, the repeated legacy signal field, the non-legacy signal field, and the repeated non-legacy signal field.

18. The wireless device of claim 16, wherein the PPDU is determined to have the particular non-legacy PPDU format further based on a determination that a length of the PPDU indicated in the legacy signal field is a multiple of three.

19. The wireless device of claim 16, wherein the PPDU is received in a 6 Gigahertz (GHz) band.

20. The wireless device of claim 16, wherein the particular non-legacy PPDU format is provided by a particular version of a wireless networking standard.
